(19) United States
(12) Patent Application Publication
(10) Pub. No.: US 2023/0289054 A1
(43) Pub. Date: Sep. 14, 2023

(54) CONTROL MODE SELECTION TO INDICATE WHETHER SIMULTANEOUS PERSPECTIVE CHANGE AND FUNCTION SELECTION IS ENABLED

(71) Applicant: Tencent Technology (Shenzhen) Company Limited, Shenzhen (CN)

(72) Inventor: Zhihong LIU, Shenzhen (CN)

(73) Assignee: Tencent Technology (Shenzhen) Company Limited, Shenzhen (CN)

(21) Appl. No.: 18/199,217

(22) Filed: May 18, 2023

Related U.S. Application Data
(63) Continuation of application No. PCT/CN2022/102206, filed on Jun. 29, 2022.

(30) Foreign Application Priority Data
Aug. 19, 2021 (CN) 202110956123.2

(51) Int. Cl. G06F 3/04883; G06F 3/04845; G06F 3/0482

(52) U.S. Cl. CPC G06F 3/04883; G06F 3/04845; G06F 3/0482

(57) ABSTRACT

A display method includes displaying a first virtual environment picture, the first virtual environment picture being a picture for observing a virtual environment including a virtual object from a first perspective, and controlling the virtual object to perform a first function in response to a first touch operation on a first function control. At least a part of the first touch operation is located in a response region of the first function control. The method further includes changing a displayed perspective of the virtual environment in response to moving a touch position of the first touch operation from a first position to a second position. At least one of the first position or the second position is located outside the response region of the first function control, and the displayed perspective of the virtual environment is changed based on the moved touch position of the first touch operation.

### RELATED APPLICATIONS

This application is a continuation of International Application No. PCT/CN2022/102206, filed on Jun. 29, 2022, which claims priority to Chinese Patent Application NO. 202110956123.2, entitled “DISPLAY METHOD AND APPARATUS OF VIRTUAL ENVIRONMENT PICTURE, TERMINAL, AND STORAGE MEDIUM” and filed on Aug. 19, 2021. The entire disclosures of the prior applications are hereby incorporated by reference in their entirety.

### FIELD OF THE TECHNOLOGY

This application relates to the technical field of computers and the Internet, including a display of a virtual environment picture.

### BACKGROUND OF THE DISCLOSURE

In a shooting game, a user may observe a virtual environment through a swiping operation on a screen.

In the related art, a function control and a virtual environment picture are displayed in a user interface. The user may control a virtual object to perform a corresponding behavior through clicking the function control, and the user also adjusts a perspective of the virtual object through the swiping operation on the screen, so that the user interface may display different virtual environment pictures. Furthermore, a click operation on an operation control and the swiping operation on the screen are mutually independent operations. After clicking the operation control, the user needs to release the finger to trigger the generation of the swiping operation on the screen. In other words, if the user does not release after clicking the operation control, a client fails to detect the swiping operation on the screen even if the user swipes the finger on the screen.

That is, in the related art mentioned above, after clicking the operation control, the user needs to release to trigger the generation of the swiping operation on the screen, which is not easy to operate.

### SUMMARY

Embodiments of this disclosure provide a display method and apparatus of a virtual environment picture, a terminal, a medium, and a program product, which may simplify a user operation and improve an adjustment efficiency of the virtual environment picture while controlling a virtual object to perform a behavior. The technical solutions are as follows.

In an embodiment, a display method includes displaying a first virtual environment picture, the first virtual environment picture being a picture for observing a virtual environment including a virtual object from a first perspective, and controlling the virtual object to perform a first function in response to a first touch operation on a first function control. At least a part of the first touch operation is located in a response region of the first function control. The method further includes changing a displayed perspective of the virtual environment in response to moving a touch position of the first touch operation from a first position to a second position. At least one of the first position or the second position is located outside the response region of the first function control, and the displayed perspective of the virtual environment is changed based on the moved touch position of the first touch operation.

In an embodiment, an apparatus for displaying a virtual environment scene includes processing circuitry configured to display a first virtual environment picture, the first virtual environment picture being a picture for observing a virtual environment including a virtual object from in a first perspective, and control the virtual object to perform a first function in response to a first touch operation on a first function control. At least a part of the first touch operation is located in a response region of the first function control. The processing circuitry is further configured to change a displayed perspective of the virtual environment in response to moving a touch position of the first touch operation from a first position to a second position. At least one of the first position or the second position is located outside the response region of the first function control, and the displayed perspective of the virtual environment is changed based on the moved touch position of the first touch operation.

In an embodiment, a non-transitory computer-readable storage medium stores computer-readable instructions thereon, which, when executed by processing circuitry, cause the processing circuitry to perform a method for displaying a virtual environment picture. The method includes displaying a first virtual environment picture, the first virtual environment picture being a picture for observing a virtual environment including a virtual object from a first perspective, and controlling the virtual object to perform a first function in response to a first touch operation on a first function control. At least a part of the first touch operation is located in a response region of the first function control. The method further includes changing a displayed perspective of the virtual environment in response to moving a touch position of the first touch operation from a first position to a second position. At least one of the first position or the second position is located outside the response region of the first function control, and the displayed perspective of the virtual environment is changed based on the moved touch position of the first touch operation.

The technical solutions provided by the embodiments of this disclosure may bring about the following beneficial effects.

The virtual object is controlled to perform the behavior corresponding to the first function control through the first touch operation on the first function control. And in a case that the touch position of the first touch operation moves from the first position to the second position located outside the response region of the first function control, the virtual object is adjusted from the first perspective to the second perspective, and further, the second virtual environment picture is displayed with the second perspective as a reference. In other words, in the same touch operation, not only may the virtual object be controlled to perform a corresponding behavior, but also the virtual environment picture may be adjusted according to changes of the touch position. When a user controls the virtual object to perform a certain behavior, the perspective of the virtual object may be adjusted by swiping the finger to adjust a displayed virtual environment picture. In a case that the user does not release the finger, a client may still respond to a swiping operation of the user, which simplifies a user operation and improves an adjustment efficiency of the virtual environment picture while controlling a virtual object to perform a behavior.

### BRIEF DESCRIPTION OF THE DRAWINGS

FIG. 1 is a schematic diagram of a virtual picture display system provided by one embodiment of this disclosure.

FIG. 2 exemplarily shows a schematic diagram of a display mode of a virtual environment picture.

FIG. 3 is a flowchart of a display method of a virtual environment picture provided by one embodiment of this disclosure.

FIG. 4 exemplarily shows a schematic diagram of a user interface.

FIG. 5 exemplarily shows a schematic diagram of a configuration interface.

FIG. 6 exemplarily shows a schematic diagram of a display mode of another virtual environment picture.

FIG. 7 exemplarily shows a schematic diagram of a display mode of still another virtual environment picture.

FIG. 8 exemplarily shows a schematic diagram of a control mode of a virtual object.

FIG. 9 exemplarily shows a schematic diagram of a control mode of another virtual object.

FIG. 10 exemplarily shows a schematic diagram of a touch mode of a first function control.

FIG. 11 is a block diagram of a display apparatus of a virtual environment picture provided by one embodiment of this disclosure.

FIG. 12 is a block diagram of a display apparatus of a virtual environment picture provided by another embodiment of this disclosure.

FIG. 13 is a structure block diagram of a terminal provided by one embodiment of this disclosure.

### DESCRIPTION OF EMBODIMENTS

In order to make the objects, technical solutions, and advantages of this disclosure more apparent, implementations of this disclosure will be described in detail with reference to the accompanying drawings.

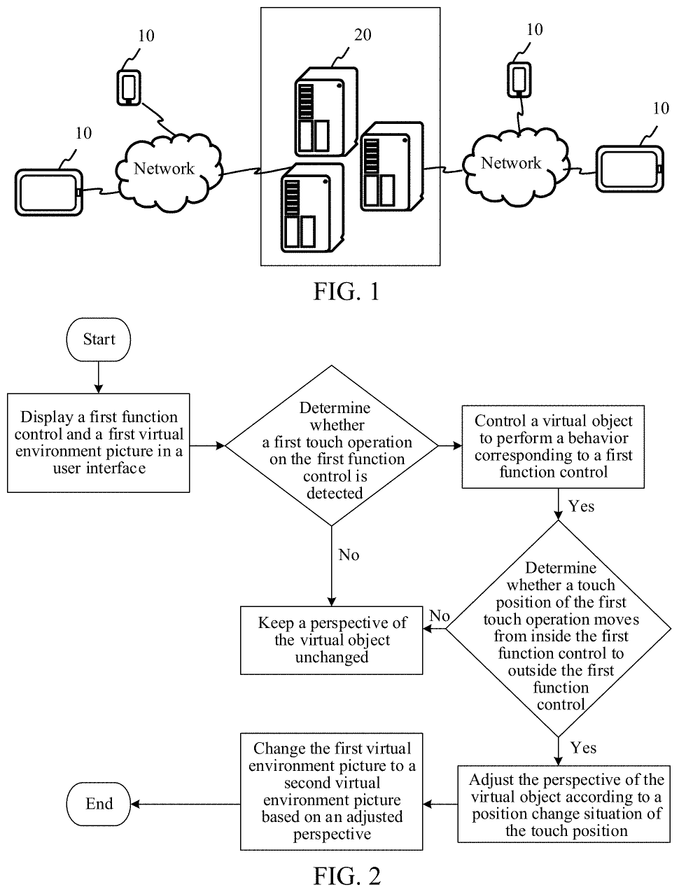

Referring to FIG. 1, a schematic diagram of a virtual picture display system provided by one embodiment of this disclosure is shown. The virtual picture display system may include: a terminal 10 and a server 20.

The terminal 10 may be an electronic device such as a mobile phone, a tablet computer, a game host, an electronic book reader, a multimedia playback device, a wearable device, and a personal computer (PC). A client of an application, such as a game application, may be installed in the terminal 10 The application may be an application that needs to be downloaded and installed, or may be a click-to-run application. This is not limited in the embodiments of this disclosure.

In an embodiment of this disclosure, the above-mentioned application may be any application capable of providing a virtual environment in which a virtual role, substituted and operated by a user, performs activities. Typically, the application may be a game application, such as a third-personal shooting game (TPS), a first-person shooting game (FPS), a battle royale (BR) game, a multiplayer online battle arena (MOBA) game, and a multiplayer gunshot survival game. Of course, in addition to the game application, other types of applications may present virtual objects to the user and provide corresponding functions to the virtual objects. Such as a virtual reality (VR) application, an augmented reality (AR) application, a three-dimensional map program, a military simulation program, a social application, and an interactive entertainment application. This is not limited in the embodiments of this disclosure. In addition, for different applications, forms of the virtual objects provided thereby will also be different, and the corresponding functions will also be different, which may all be pre-configured according to actual requirements. This is not limited in the embodiments of this disclosure. In an embodiment, a client of the above-mentioned application runs in the terminal 10. In some embodiments, the above-mentioned application is an application developed based on a three-dimensional virtual environment engine, for example, the virtual environment engine is a Unity engine. The virtual environment engine enables to construct three-dimensional virtual environments, virtual objects, and virtual props, etc. to bring a more immersive game experience to the user.

The above-mentioned virtual environment is a scenario displayed (or provided) when the client of the application (such as a game application) runs on the terminal, and the virtual environment refers to a scenario created for the virtual object to perform activities (such as a game competition), such as a virtual house, a virtual island, and a virtual map. The virtual environment may be a real-world simulation environment, a semi-simulation semi-fictional environment, or a purely fictional environment. The virtual environment may be a two-dimensional virtual environment, a 2.5-dimensional virtual environment, or a three-dimensional virtual environment. This is not limited in the embodiments of this disclosure.

The above-mentioned virtual object may be a virtual character controlled by a user account in the application or a virtual character controlled by a computer program in the application. Taking the application as a game application for an example, the virtual object may be a game character controlled by a user account in the game application or a game monster controlled by a computer program in the game application. The virtual object may be in forms of a person, an animal, a cartoon, or other forms. This is not limited in the embodiments of this disclosure. The virtual object may be presented in a three-dimensional form or a two-dimensional form. This is not limited in the embodiments of this disclosure. In an embodiment, when the virtual environment is the three-dimensional virtual environment, the virtual object is a three-dimensional stereo model created based on an animated skeleton technology. Each virtual object has its own shape and volume in the three-dimensional virtual environment, occupying a portion of the space in the three-dimensional virtual environment.

In an embodiment of this disclosure, during the running of an application in the terminal 10, the user may also adjust the perspective of the virtual object in the virtual environment when controlling the virtual object to perform a behavior. Illustratively, as shown in FIG. 2, during the running of the application, the terminal 10 displays a first function control and a first virtual environment picture in a user interface. Further, the terminal 10 determines whether a first touch operation on the first function control is detected. If the first touch operation on the first function control is detected, the virtual object is controlled to perform a behavior corresponding to the first function control. And if the first touch operation for the first function control is not detected, the perspective of the virtual object is kept unchanged. In addition, when the first touch operation on the first function control is detected, the terminal 10 determines whether the touch position of the first touch operation moves from inside the first function control to outside the first function control. If the touch position of the first touch operation moves from inside the first function control to outside the first function control, the perspective of the virtual object is adjusted according to a position change situation of the touch position, and the first virtual environment picture is changed to a second virtual environment picture based on an adjusted perspective. If the touch position of the first touch operation does not move from inside the first function control to outside the first function control, the perspective of the virtual object is kept unchanged.

The server 20 is configured to provide background services to the client of the application in the terminal 10. For example, the server 20 may be a background server for the above-mentioned game application. The server 20 may be one server, a server cluster including a plurality of servers, or a cloud computing service center. In an embodiment, the server 20 simultaneously provides background services for applications in multiple terminals 10.

The terminal 10 and the server 20 may communicate with each other through a network.

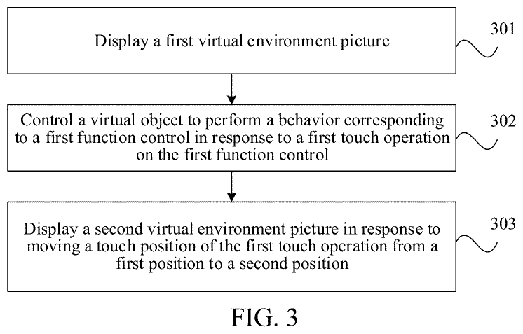

Referring to FIG. 3, a flowchart of a display method of a virtual environment picture provided by one embodiment of this disclosure is shown. The method may be applied to the terminal 10 of the virtual picture display system shown in FIG. 1, for example, an execution subject of each step may be the client of the application installed in the terminal 10. The method may include the following steps (301-303). The method may also include obtaining a control mode selection (i) indicating whether perspective change of the virtual environment picture simultaneously with function selection is enabled when an initial position of the function selection is within a response region of a function control and (ii) indicating whether the perspective change of the virtual environment picture simultaneously with the function selection is enabled when the initial position of the function selection is outside the response region of the function control.

Step 301: Display the first virtual environment picture. For example, a first virtual environment picture is displayed. The first virtual environment picture is a picture observing a virtual environment including a virtual object from a first perspective.

The virtual environment picture refers to a display picture of the virtual environment presented to the user on the user interface. The virtual environment picture may be a picture acquired by a virtual camera from the virtual environment. In a possible implementation, the virtual camera acquires the virtual environment picture in a third person perspective of the virtual object. In an embodiment, the virtual camera is set diagonally above the virtual object, and the client observes the virtual environment with the virtual object as a center through the virtual camera and acquires and displays a virtual environment picture with the virtual object as a center. In another possible implementation, the virtual camera acquires the virtual environment picture in a first person perspective of the virtual object. In an embodiment, the virtual camera is set directly in front of the virtual object, and the client observes the virtual environment in the first person perspective of the virtual object through the virtual camera and acquires and displays a virtual environment picture in the first person perspective of the virtual object.

In an embodiment of this disclosure, during the running of the above-mentioned application, the client displays the first virtual environment picture. The first virtual environment picture is a picture for observing the virtual environment in a first perspective of the virtual object. The virtual object refers to a virtual object controlled by the user in the application, and the first perspective refers to any perspective of the virtual object. The above-mentioned first perspective is used for representing an orientation of the virtual object when observing the virtual environment, and the above-mentioned first person perspective and the above-mentioned third person perspective are not limited. The first perspective may be any perspective in the first person perspective or any perspective in the third person perspective. This is not limited in the embodiments of this disclosure.

In an embodiment, in an embodiment of this disclosure, the orientation of the above-mentioned virtual camera is adjustable in real time, i.e., the user may adjust the perspective of the virtual object according to actual situations. For example, the user may adjust the orientation of the virtual camera through a swiping operation on the user interface to adjust the perspective of the virtual object. Of course, in an exemplary embodiment, a placement position of the above-mentioned virtual camera is adjustable in real time. For example, the user controls the virtual object to move in the virtual environment through a joystick, changes a position of the virtual object in the virtual environment, and thus changes a placement position of the virtual camera in the virtual environment. As another example, through clicking a certain position in a map presentation control, the user takes the position as an adjusted placement position for the virtual camera. The above-mentioned map presentation control refers to a control for presenting a global map in shooting application.

Step 302: Control the virtual object to perform the behavior corresponding to the first function control in response to the first touch operation on the first function control. For example, the virtual object may be controlled to perform the first function in response to a first touch operation on a first function control. At least a part of the first touch operation is located in a response region of the first function control.

A function control is configured to control the virtual object to perform a corresponding operation, and behaviors corresponding to different function controls are different. In an embodiment, in an embodiment of this disclosure, at least one function control is included in the user interface. In a possible implementation, the function control is displayed directly in the user interface. In an embodiment, at least one function control provided for the user by the above-mentioned application in the user interface is displayed when the user displays the first virtual environment picture. In another possible implementation, the function control is hidden in the user interface. In an embodiment, a response region of the at least one function control provided for the user by the above-mentioned application is determined in the user interface when the user interface displays the first virtual environment picture. In order to ensure the neatness of the user interface, the at least one function control is not displayed in the user interface. In yet another possible implementation, the function control is semi-hidden in the user interface. In an embodiment, a response region of the at least one function control provided for the user by the above-mentioned application is determined in the user interface when the user interface displays the first virtual environment picture. When any touch operation of the user on a response region of a certain function control is detected, the function control is displayed in the user interface, facilitating the user to determine whether the function control is a required function control.

A touch operation refers to an operation triggered by a user. The touch operation may be an operation on any position in the user interface. The above-mentioned touch operation may be a single click operation, a double click operation, the swiping operation, etc. This is not limited in the embodiments of this disclosure. In an embodiment, touch operations corresponding to different positions in the user interface are different. Illustratively, a touch operation corresponding to the function control in the user interface is the single click operation, and the user controls the virtual object to perform a behavior corresponding to the function control through clicking the function control once. A touch operation corresponding to the display region of the virtual environment picture in the user interface is the swiping operation. The user adjusts the perspective of the virtual object through the swiping operation on the display region so that the user interface displays a new virtual environment picture.

The first touch operation refers to a touch operation on the first function control, and the first function control refers to any one of the above-mentioned at least one function control. In an embodiment of this disclosure, after displaying the above-mentioned first virtual environment picture, the client detects the user interface, and in a case that the first touch operation on the first function control is detected, the client controls the virtual object to perform the behavior corresponding to the first function control. An initial touch position of the first touch operation is a first position located in a response region of the first function control, and the first position refers to any position in the response region of the first function control.

The response region of the above-mentioned first function control may be any region in the user interface.

In a possible implementation, the first function control is displayed directly or semi-hidden in the user interface. In an embodiment, the response region of the first function control is a region with a display region of the first function control as a center and having an area greater than or equal to the display region. Illustratively, the response region of the first function control is the display region of the first function control. A shape of the response region of the first function control may be the same as or different from a shape of the display region of the first function control. This is not limited in the embodiments of this disclosure.

In another possible implementation, the first function control is hidden in the user interface. The response region of the first function control may be a region set by a designer according to user habits. Illustratively, since the user is accustomed to left-hand control of virtual object movement and right-hand control of virtual object release skill, the designer may set a response region of a function control for controlling virtual object movement to the left side of the user interface and a response region of a function control for controlling virtual object release skill to the right side of the user interface.

The above-mentioned behavior may be any behavior, such as an item usage behavior, a posture conversion behavior, and a skill usage behavior. This is not limited in the embodiments of this disclosure.

In a possible implementation, the above-mentioned behavior is the item usage behavior. In an embodiment, the client determines a virtual item corresponding to the first function control and controls the virtual object to use the virtual item in a case that the first touch operation on the above-mentioned first function control is detected. In an exemplary embodiment, the above-mentioned virtual item may also be referred to as a virtual weapon, such as a virtual firearm, a virtual bullet, and a virtual explosive. In an embodiment, in an embodiment of this disclosure, the function controls corresponding to different virtual items are different. Alternatively, the function controls corresponding to different virtual items are the same, but the corresponding touch operations are different.

In another possible implementation, the above-mentioned behavior is a posture conversion behavior. In an embodiment, the client determines a posture corresponding to the first function control and controls a conversion of the virtual object from the current posture to the posture corresponding to the first function control in a case that the first touch operation on the above-mentioned first function control is detected. The posture of the virtual object may include a standing posture, a squat posture, a crouch posture, a jumping posture, etc. This is not limited in the embodiments of this disclosure. In an embodiment, in an embodiment of this disclosure, the function controls corresponding to different postures are different. Alternatively, the function controls corresponding to different postures are the same, but the corresponding touch operations are different.

In yet another possible implementation, the above-mentioned behavior is a skill release behavior. In an embodiment, the client determines a skill corresponding to the first function control and controls the virtual object to release the skill corresponding to the first function control in a case that the first touch operation on the above-mentioned first function control is detected. In an embodiment, in an embodiment of this disclosure, the function controls corresponding to different skills are different. Alternatively, the function controls corresponding to different skills are the same, but the corresponding touch operations are different.

Step 303: Display the second virtual environment picture in response to moving a touch position the first touch operation from the first position to a second position. For example, a displayed perspective of the virtual environment is changed in response to moving a touch position of the first touch operation from a first position to a second position. At least one of the first position or the second position is located outside the response region of the first function control, and the displayed perspective of the virtual environment is changed based on the moved touch position of the first touch operation.

The second position is a position located outside the response region of the first function control. In other words, in an embodiment of this disclosure, after detecting the above-mentioned first touch operation, the client detects the touch position of the first touch operation. The second virtual environment picture is displayed in a case that the touch position of the first touch operation moves from the above-mentioned first position to the second position located outside the response region of the first function control. The second position may be any position outside the response region of the first function control. The second virtual environment picture is a picture for observing the virtual environment in a second perspective of the virtual object, and the second perspective and the first perspective have different orientations. Similar to the above-mentioned first perspective, the second perspective is merely used for representing the orientation of the virtual object when observing the virtual environment, and the above-mentioned first person perspective and the above-mentioned third person perspective are not limited.

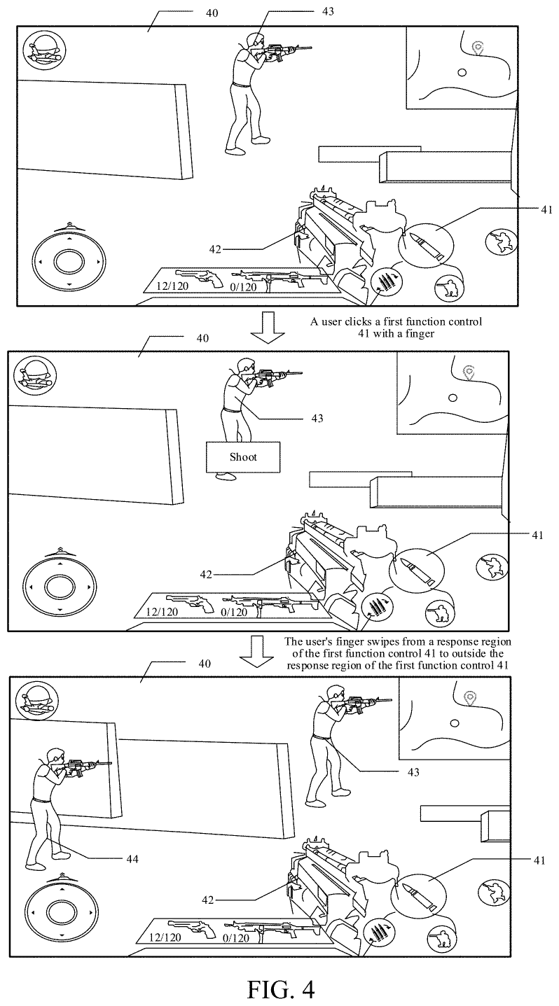

Since a change process of the touch position of the above-mentioned first touch operation is continuous, the above-mentioned first touch operation may also be referred to as the swiping operation during the change process of the touch position. Illustratively, taking shooting application as an example, as shown in FIG. 4, a user interface 40 includes the first virtual environment picture and a first function control 41 (a shooting button). When the user clicks the first function control 41 with a finger, the client determines that a first touch operation on the first function control 41 is detected and controls the virtual object to use a virtual weapon 42 to shoot an enemy virtual object 43. Thereafter, when the user's finger swipes from the response region of the first function control 41 to outside the response region of the first function control 41, the client determines that the first touch operation includes the swiping operation and adjusts an orientation of the perspective of the virtual object based on the swiping operation, thereby displaying the second virtual environment picture in the user interface 40. The second virtual environment picture includes a newly occurring virtual object 44.

In summary, in the technical solutions provided by embodiments of this disclosure, the virtual object is controlled to perform the behavior corresponding to the first function control through the first touch operation on the first function control. And in a case that the touch position of the first touch operation moves from the first position to the second position located outside the response region of the first function control, the virtual object is adjusted from the first perspective to the second perspective, and further, the second virtual environment picture is displayed with the second perspective as a reference. In other words, in the same touch operation, not only the virtual object enables to be controlled to perform a corresponding behavior, but also the virtual environment picture enables to be adjusted according to changes of the touch position. When a user controls the virtual object to perform a certain behavior, the perspective of the virtual object may be adjusted by swiping the finger to adjust a displayed virtual environment picture. In a case that the user does not release the finger, a client may still respond to a swiping operation of the user, which simplifies a user operation and improves an adjustment efficiency of the virtual environment picture while controlling a virtual object to perform a behavior.

A display mode of the above-mentioned second virtual environment picture is introduced below.

In an exemplary embodiment, the above-mentioned step 303 includes the following steps.

1. Acquire the touch position of the first touch operation.

The touch position refers to a current contact position between the first touch operation and the user interface. Illustratively, if the first touch operation is a click operation, the touch position is a click position of the click operation. If the first touch operation is the swiping operation, the touch position is a current swiping end position of the swiping operation.

In an embodiment of this disclosure, after detecting the above-mentioned first touch operation, the client detects the touch position of the first touch operation in real time and acquires the touch position of the first touch operation.

2. Calculate a distance between the touch position of the first touch operation and a reference position of the first function control.

In an embodiment of this disclosure, after acquiring the above-mentioned touch position, the client calculates the distance between the touch position of the first touch operation and the reference position of the first function control. The reference position may be a center position of the first function control.

3. Determine the touch position being located outside the response region of the first function control in a case that the distance is greater than a threshold, take the touch position as the second position and display the second virtual environment picture.

In an embodiment of this disclosure, after acquiring the distance between the touch position and the reference position, the client compares the distance with the threshold. Further, the current touch position is taken as the second position to display the second virtual environment picture in a case that the distance is greater than the threshold. An orientation of the first perspective of the virtual object is kept unchanged in a case that the distance is less than or equal to the threshold. The above-mentioned threshold is greater than or equal to a maximum distance between the center position of the first function control and an edge position of the first function control.

Through taking the distance between the current touch position and the reference position as a determining basis, it can be accurately determined whether the current touch position is already outside the response region of the first function control, thereby improving the response speed and accuracy of adjusting the perspective.

In an embodiment, in an embodiment of this disclosure, the client determines that the touch position of the first touch operation moves from the response region of the first function control to outside the response region of the first function control in a case that the distance is determined to be greater than the threshold, and further, the client acquires direction information of the touch position of the first touch operation relative to the reference position, determines an orientation of the above-mentioned second perspective according to the direction information, and then displays the above-mentioned second virtual environment picture based on the orientation of the second perspective.

Since direction information of the second position relative to the reference position may intuitively reflect an orientation of the current touch position relative to the first function control, the user can accurately control an adjustment of the perspective direction based on the orientation to improve the accuracy of the adjustment of the perspective.

Since the movement of the virtual object can also change the virtual environment picture, the first virtual environment picture may change due to the movement of the virtual object in the virtual environment in a case that the orientation of the first perspective of the virtual object is kept unchanged.

Of course, in an exemplary embodiment, the above-mentioned reference position may also be an edge point of the first function control that the first touch operation passes through during a position movement, and correspondingly, the above-mentioned threshold is any value greater than zero.

In an embodiment, the above-mentioned direction information includes a movement direction and a movement distance. The client determines an orientation change direction of the first perspective according to a movement direction of the touch position on the reference position, and determines an orientation change angle of the first perspective according to a movement distance of the touch position on the reference position. And further, the client adjusts the first perspective to the second perspective according to the orientation change direction and the orientation change angle.

In an embodiment, in an embodiment of this disclosure, the user may perform customized adjustment on an adjustment rule (i.e., a custom operation rule or control mode) corresponding to the virtual environment picture according to actual situations, and the specific steps are as follows.

1. Acquire the custom operation rule.

The custom operation rule is an operation rule selected from a plurality of candidate operation rules. In an embodiment, the plurality of candidate operation rules (candidate control modes) include a first operation rule. The first operation rule is an operation rule where for a touch operation on the initial touch position located in a response region of a function control, the touch position of the touch operation fails to trigger steering when moving in the response region of the function control and the touch position of the touch operation triggers steering when moving outside the response region of the function control. Of course, in an exemplary embodiment, the plurality of candidate operation rules further include at least one of a second operation rule and a third operation rule. The second operation rule is an operation rule where for the touch operation on the initial touch position located in the response region of the function control, the touch position of the touch operation fails to trigger steering when moving. The third operation rule is an operation rule where for the touch operation on the initial touch position located in the response region of the function control, the touch position of the touch operation triggers steering when moving. The steering refers to a change in the orientation of the perspective on the virtual object.

Illustratively, taking the first function control as an example, the above-mentioned three operation rules and the steering trigger condition of the virtual object are introduced in combination with table 1.

TABLE 1
A corresponding relationship between the operation
rule and the steering trigger condition of the virtual object

| | Trigger position in | Trigger position outside |
|---|---|---|
| Custom operation rule | the response region | the response region |
| First operation rule | Unable to trigger steering | Enable to trigger steering |
| Second operation rule | Unable to trigger steering | Unable to trigger steering |
| Third operation rule | Enable to trigger steering | Enable to trigger steering |

The trigger position in table 1 refers to a trigger position of the first touch operation on the first function control, and a response region refers to the response region of the first function control.

In an embodiment of this disclosure, the client acquires the above-mentioned custom operation rule through a selection operation of the user in a configuration interface. In an embodiment, when acquiring the above-mentioned custom operation rule, the client firstly displays the configuration interface, where the configuration interface includes selection items corresponding to the plurality of candidate operation rules. Further, the client sets a target operation rule as the custom operation rule when detecting an operation on a selection item corresponding to a target operation rule in the plurality of candidate operation rules. The above-described operation on the selection item may also be referred to as a selection operation.

A candidate operation rule may be displayed intuitively through the configuration interface, which helps the user to accurately select a required candidate operation rule.

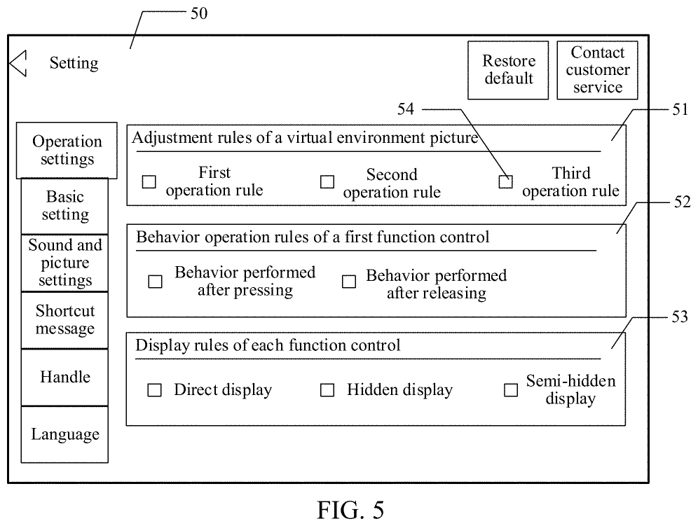

Of course, in an exemplary embodiment, the above-mentioned configuration interface may also include selection items of other content, such as a selection item of the response regions of the function control, a selection item of a display rule of the function control, a selection item of a display region of the function control, and a behavior operation rule of the function control. Illustratively, as shown in FIG. 5, a configuration interface 50 includes adjustment rules of the virtual environment picture 51, behavior operation rules of the first function control 52, and display rules of each function control 53. The adjustment rules of the virtual environment picture 51 include the first operation rule, the second operation rule, and the third operation rule. The behavior operation rules of the first function control 52 include a behavior performed after pressing and a behavior performed after releasing. The display rules of each function control include a direct display, a hidden display, and a semi-hidden display. Furthermore, a selection item 54 is included before each rule.

2. Perform, in a case that the custom operation rule is the first operation rule, the step 303 of displaying the second virtual environment picture in response to moving a touch position the first touch operation from the first position to a second position.

A display mode of the virtual environment picture corresponding to the first operation rule is the display mode of the virtual environment picture introduced in the above-mentioned embodiment of FIG. 3, with particular reference to the embodiment of FIG. 3, which will not be repeated here.

Through the above-mentioned custom operation rule, users may select corresponding custom operation rules to operate based on their usage habits to improve flexibility.

3. Control the virtual object to keep the first perspective unchanged in response to moving the touch position of the first touch operation, in a case that the custom operation rule is the second operation rule.

In an embodiment, in an embodiment of this disclosure, in a case that the above-mentioned custom operation rule is the second operation rule, after detecting the first touch operation of the above-mentioned first function control, the client controls the virtual object to perform the behavior corresponding to the first function control. Further, the client controls the virtual object to keep the first perspective unchanged in a case that the touch position of the first touch operation is detected to move.

When the client controls the virtual object to keep the first perspective unchanged, merely the orientation of the first perspective keeps unchanged, and therefore, in this case, when a position of the virtual object changes due to the movement of the virtual object, the first virtual environment picture changes correspondingly with the change of the position of the virtual object.

In an embodiment, in an embodiment of this disclosure, the client receives a second touch operation after controlling the virtual object to perform a behavior corresponding to the first function control. An initial touch position of the second touch operation is a third position located outside the response region of the first function control. Further, the client displays a third virtual environment picture when detecting a touch position of the second touch operation moves from the third position to a fourth position in a case that the custom operation rule is the second operation rule. The third virtual environment picture is a picture for observing the virtual environment in a third perspective of the virtual object. The third perspective and the second perspective have different orientations. Similar to the above-mentioned first perspective, the third perspective is merely used for representing the orientation of the virtual object when observing the virtual environment, and the above-mentioned first person perspective and the above-mentioned third person perspective are not limited.

The above-mentioned third position may be any position outside the response region of the first function control. Alternatively, the above-mentioned third position may be any position in a target region. The target region may be a portion of the remaining region in the user interface except the response region of each function control, or may be all of the remaining region in the user interface except the response region of each function control.

The above-mentioned fourth position may be any position except the third position outside the response region of the first function control. Alternatively, the above-mentioned fourth position may be any position in the target region except the third position. Alternatively, the above-mentioned fourth position may be any position in the user interface except the third position.

This target region may be a portion of the remaining region in the user interface except the response region of each function control, or may be all of the remaining region in the user interface except the response region of each function control.

Since a change process of the touch position of the above-mentioned second touch operation is continuous, the above-mentioned second touch operation may also be referred to as the swiping operation during the change process of the touch position.

It can be seen that in an embodiment of this disclosure, the user may also conveniently control a perspective orientation of the first virtual object based on the swiping operation without touching the first function control, simplifying the operation.

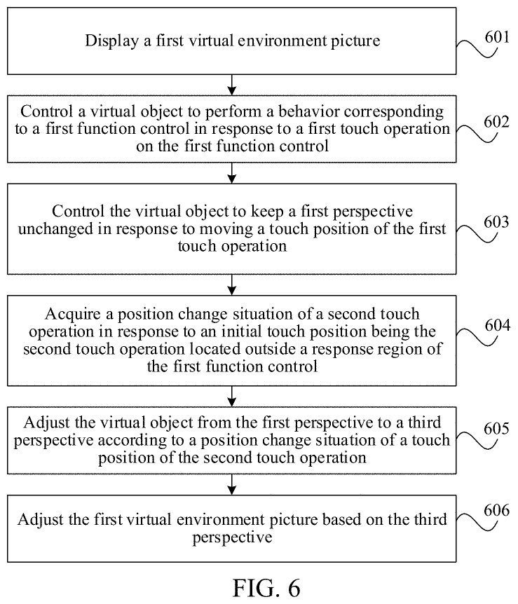

Illustratively, referring to FIG. 6, the display mode of the virtual environment picture in the second operation rule is introduced, and the specific steps are as follows.

Step 601: Display the first virtual environment picture.

Step 602: Control the virtual object to perform the behavior corresponding to the first function control in response to the first touch operation on the first function control.

Step 603: Control the virtual object to keep the first perspective unchanged in response to moving the touch position of the first touch operation.

Step 604: Acquire a position change situation of the second touch operation in response to the initial touch position being the second touch operation located outside the response region of the first function control.

Step 605: Adjust the virtual object from the first perspective to the third perspective according to the position change situation of the touch position of the second touch operation.

Step 606: Adjust the first virtual environment picture based on the third perspective.

4. Display a fourth virtual environment picture in response to moving the touch position of the first touch operation from the first position to a fifth position located in the response region of the first function control, in a case that the custom operation rule is the third operation rule.

In an embodiment, in an embodiment of this disclosure, in a case that the above-mentioned custom operation rule is the third operation rule, after detecting the first touch operation of the above-mentioned first function control, the client controls the virtual object to perform the behavior corresponding to the first function control. Further, the fourth virtual environment picture is displayed in a case that the touch position of the first touch operation is detected to move from the first position to the fifth position located in the response region of the first function control. The fourth virtual environment picture is a picture for observing the virtual environment in a fourth perspective of the virtual object, and the fourth perspective and the first perspective have different orientations. The above-mentioned fifth position may be any position except the first position. Similar to the above-mentioned first perspective, the fourth perspective is merely used for representing the orientation of the virtual object when observing the virtual environment, and the above-mentioned first person perspective and the above-mentioned third person perspective are not limited.

In the above-mentioned third operation rule, the client may adjust the first perspective of the virtual object to adjust the first virtual environment picture in a case that the touch position of the first touch operation is detected to move from the first position to any position except the first position.

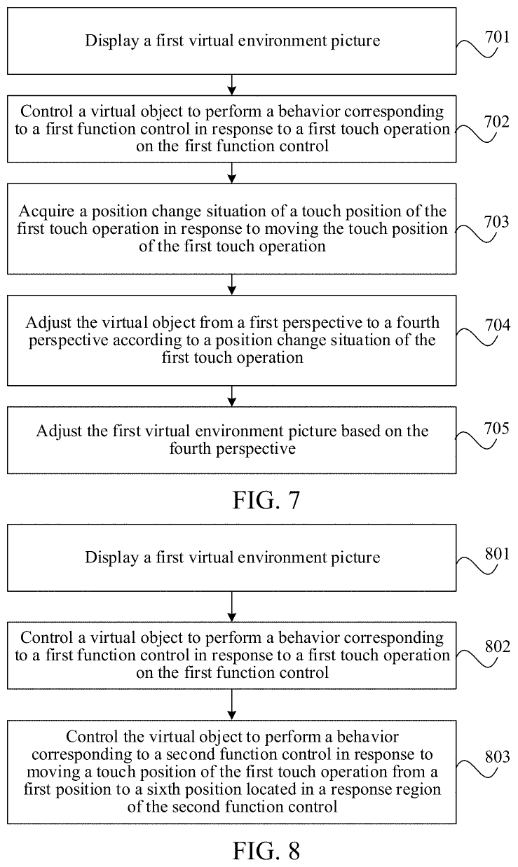

Illustratively, referring to FIG. 7, the display mode of the virtual environment picture in the third operation rule is introduced, and the specific steps are as follows.

Step 701: Display the first virtual environment picture.

Step 702: Control the virtual object to perform the behavior corresponding to the first function control in response to the first touch operation on the first function control.

Step 703: Acquire a position change situation of the touch position of the first touch operation in response to moving the touch position of the first touch operation.

Step 704: Adjust the virtual object from the first perspective to the fourth perspective according to the position change situation of the first touch operation.

Step 705: Adjust the first virtual environment picture based on the fourth perspective.

An adjustment on the first perspective mentioned in this disclosure is merely an adjustment on the orientation of the first perspective and does not limit an adjustment on the position of the first perspective unless otherwise specified. In an embodiment, as the virtual object moves, a position of the virtual camera changes following the position of the virtual object, resulting in a change in a position of the first perspective of the virtual object.

In the following, a control mode of the virtual object in this disclosure is introduced from an execution of a behavior.

Referring to FIG. 8, a flowchart of the control mode of the virtual object provided by one embodiment of this disclosure is shown. The method may be applied to the terminal 10 of the virtual picture display system shown in FIG. 1, for example, the execution subject of each step may be the client of the application installed in the terminal 10. The method may include the following steps (801-803).

Step 801: Display the first virtual environment picture.

Step 802: Control the virtual object to perform the behavior corresponding to the first function control in response to the first touch operation on the first function control.

The above-mentioned steps 801 and 802 are the same as steps 301 and 302 in the embodiment of FIG. 3, with particular reference to the embodiment of FIG. 3, which will not be repeated here.

Step 803: Control the virtual object to perform a behavior corresponding to a second function control in response to moving the touch position (selection position) of the first touch operation from the first position to a sixth position located in a response region of the second function control.

In an embodiment of this disclosure, after detecting the above-mentioned first touch operation, the client detects the touch position of the first touch operation. And the client controls the virtual object to perform the behavior corresponding to the second function control if the touch position of the first touch operation moves from the first position to a sixth position located in a response region of a second function control. The second function control refers to any of the above-mentioned at least one function control except the first function control, and the sixth position refers to any position in the response region of the second function control.

In other words, the user may control the virtual object to perform a plurality of behaviors in one touch operation, for example, the behavior corresponding to the first function control and the behavior corresponding to the second function control effectively reduce the number of touches and simplify control difficulties.

In an embodiment, in an embodiment of this disclosure, before controlling the virtual object to perform the above-mentioned behavior corresponding to the second touch operation, the client needs to determine the behavior corresponding to the second touch operation and the above-mentioned behavior corresponding to the first function control. In a case that the behavior corresponding to the second function control and the behavior corresponding to the first function control are non-mutually exclusive behaviors, when the touch position of the first touch operation is detected to move from the first position to the above-mentioned sixth position, the client controls the virtual object to perform the behavior corresponding to the second function control. In a case that the behavior corresponding to the second function control and the behavior corresponding to the first function control are mutually exclusive behaviors, when the touch position of the first touch operation is detected to move from the first position to the above-mentioned sixth position, the client controls the virtual object to skip performing the behavior corresponding to the second function control.

The mutually exclusive behaviors refer to two behaviors that cannot be continuously performed. Illustratively, it is assumed that in the posture conversion behavior of the virtual object, the crouch posture may be converted into the standing posture, the standing posture may be converted into the jumping posture, and the crouch posture cannot be converted into the jumping posture. In this case, a conversion behavior of the crouch posture and a conversion behavior of the jumping posture are mutually exclusive behaviors. If the first function control is configured to indicate that the virtual object is converted into the crouch posture, and the second function control is configured to indicate that the virtual object is converted into the jumping posture, the client cannot control that the virtual object is converted into the jumping gesture when the touch position of the first touch operation is detected to move from the first position to the above-mentioned sixth position.

In summary, in the technical solutions provided by embodiments of this disclosure, through moving the touch position of the first touch operation, the virtual object can be controlled to continue executing the behavior corresponding to the second function control after executing the behavior corresponding to the first function control, improving a control efficiency of the virtual object.

Furthermore, in the embodiment of FIG. 3, through moving the touch position of the first touch operation, after controlling the virtual object to perform the behavior corresponding to the first function control, the first perspective of the virtual object can be adjusted to observe the virtual environment. At this time, while observing the virtual environment, according to actual situations, the user may continue to move the touch position of the first touch operation to the response region of the second function control to control the virtual object to perform the behavior corresponding to the second function control, simplifying the user operation while improving the efficiency of a behavior execution of the virtual object, so that the behavior execution of the virtual object is more coherent.

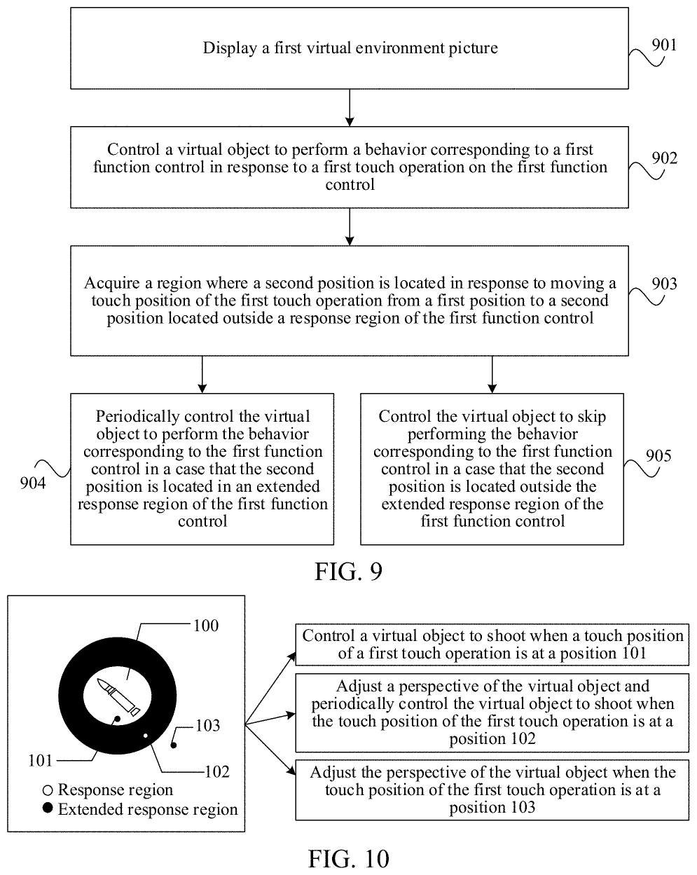

Referring to FIG. 9, a flowchart of the control mode of the virtual object provided by another embodiment of this disclosure is shown. The method may be applied to the terminal 10 of the virtual picture display system shown in FIG. 1, for example, the execution subject of each step may be the client of the application installed in the terminal 10. The method may include the following steps (901-905).

Step 901: Display the first virtual environment picture.

Step 902: Control the virtual object to perform the behavior corresponding to the first function control in response to the first touch operation on the first function control.

The above-mentioned steps 901 and 902 are the same as steps 301 and 302 in the embodiment of FIG. 3, with particular reference to the embodiment of FIG. 3, which will not be repeated here.

Step 903: Acquire a region where the second position is located in response to moving the touch position of the first touch operation from the first position to the second position located outside the response region of the first function control.

In an embodiment of this disclosure, after detecting the above-mentioned first touch operation, the client detects the touch position of the first touch operation. And the client acquires the region where the second position is located if the touch position of the first touch operation moves from the first position to the second position located outside the response region of the first function control.

In an embodiment, in an embodiment of this disclosure, the above-mentioned first function control corresponds to an extended response region, and the extended response region of the first function control surrounds the response region of the first function control.

Step 904: Periodically (repeatedly) control the virtual object to perform the behavior corresponding to the first function control in a case that the second position is located in the extended response region of the first function control.

In an embodiment, in an embodiment of this disclosure, if the above-mentioned second position is located in the extended response region of the first function control, the client periodically controls the virtual object to perform the behavior corresponding to the first function control in a case that the touch position of the first touch operation is detected to move from the first position to the second position.

Step 905: Control the virtual object to skip performing the behavior corresponding to the first function control in a case that the second position is located outside the extended response region of the first function control.

In an embodiment, in an embodiment of this disclosure, if the above-mentioned second position is located outside the extended response region of the first function control, the client controls the virtual object to skip performing the behavior corresponding to the first function control in a case that the touch position of the first touch operation is detected to move from the first position to the second position.

In an embodiment, in an embodiment of this disclosure, the above-mentioned virtual environment is a virtual environment in shooting application. Illustratively, taking the first function control as the shooting button as an example, as shown in FIG. 10, the client controls the virtual object to shoot in a case that the touch position of the first touch operation is a position 101 (the initial touch position) in a response region (a display region) of a shooting button 100. Then, in a case that the touch position of the first touch operation moves from the position 101 to a position 102 in the extended response region of the shooting button 100, the client periodically controls the virtual object to shoot while adjusting the perspective of the virtual object. And then, in a case that the touch position of the first touch operation moves from the position 102 to a position 103 outside the extended response region of the shooting button 100, the client merely adjusts the perspective of the virtual object and controls the virtual object not to shoot.

In summary, in the technical solutions provided by embodiments of this disclosure, when the touch position of the first function control is located in the extended response region of the first function control, the virtual object is periodically controlled to perform the behavior corresponding to the first function control, so that a behavior execution mode of the virtual object is more flexible, improving the degree of flexibility of the user when controlling the virtual object to perform the behavior.

Furthermore, in the embodiment of FIG. 3, through moving the touch position of the first touch operation, after controlling the virtual object to perform the behavior corresponding to the first function control, the first perspective of the virtual object can be adjusted to observe the virtual environment. In this case, while controlling the virtual object to observe the virtual environment, the user can appropriately swipe the touch position of the first touch operation to the extended response region of the first function control according to actual situations to timely control the virtual object to react to the virtual environment and perform the behavior corresponding to the first function control.

The following is an apparatus embodiment of this disclosure that may be used for performing method embodiments of this disclosure. For details not disclosed in the apparatus embodiment of this disclosure, please refer to method embodiments of this disclosure.

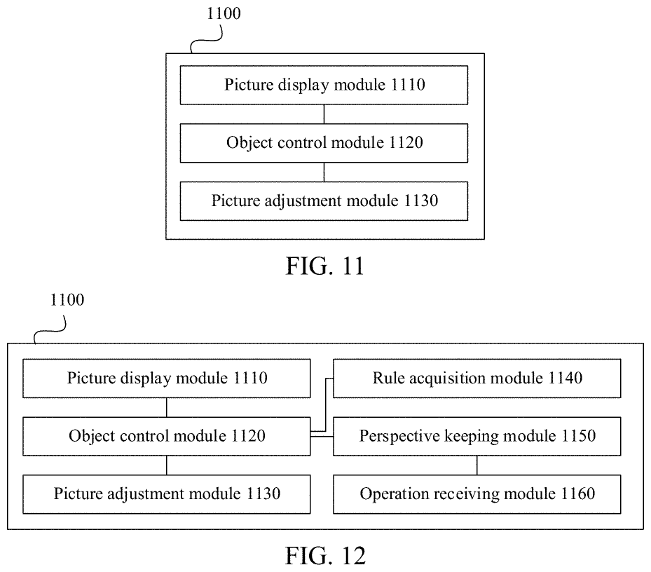

Referring to FIG. 11, a block diagram of a display apparatus of the virtual environment picture provided by one embodiment of this disclosure is shown. This apparatus has a function of implementing the above-mentioned display method of the virtual environment picture, and the function may be implemented by hardware or by hardware executing corresponding software. This apparatus may be the terminal or may be also provided in the terminal. This apparatus 1000 may include: a picture display module 1110, an object control module 1120, and a picture adjustment module 1130.

The picture display module 1110 is configured to display the first virtual environment picture, and the first virtual environment picture is a picture for observing the virtual environment in the first perspective of the virtual object.

The object control module 1120 is configured to control the virtual object to perform the behavior corresponding to the first function control in response to the first touch operation on the first function control. The initial touch position of the first touch operation is the first position located in the response region of the first function control.

The picture adjustment module 1130 is configured to display the second virtual environment picture in response to moving the touch position of the first touch operation from the first position to the second position. The second position is the position located outside the response region of the first function control, the second virtual environment picture is the picture for observing the virtual environment in the second perspective of the virtual object, and the second perspective and the first perspective have different orientations.

In an exemplary embodiment, the picture adjustment module 1130 is configured to acquire the touch position of the first touch operation, to calculate the distance between the touch position of the first touch operation and the reference position of the first function control, and to determine the touch position being located outside the response region of the first function control in a case that the distance is greater than a threshold, take the touch position as the second position, and display the second virtual environment picture.

In an exemplary embodiment, the picture adjustment module 1130 is configured to acquire direction information of the second touch position relative to the reference position, to determine the orientation of the second perspective according to the direction information, and to display the second virtual environment picture based on the orientation of the second perspective.

In an exemplary embodiment, as shown in FIG. 12, the apparatus 1100 also includes: a rule acquisition module 1140.

The rule acquisition module 1140 is configured to acquire the custom operation rule. The custom operation rule is one operation rule selected from a plurality of candidate operation rules. The plurality of candidate operation rules include the first operation rule, and the plurality of candidate operation rules also include at least one of the second operation rule and the third operation rule. The first operation rule is the operation rule where for the touch operation on the initial touch position located in the response region of the function control, the touch position of the touch operation fails to trigger steering when moving in the response region of the function control and the touch position of the touch operation triggers steering when moving outside the response region of the function control. The second operation rule is the operation rule where for the touch operation on the initial touch position located in the response region of the function control, the touch position of the touch operation fails to trigger steering when moving. The third operation rule is the operation rule where for the touch operation on the initial touch position located in the response region of the function control, the touch position of the touch operation triggers steering when moving.

The picture adjustment module 1130 is also configured to perform the step of displaying the second virtual environment picture in response to moving a touch position the first touch operation from the first position to a second position, in a case that the custom operation rule is the first operation rule.

In an exemplary embodiment, as shown in FIG. 12, the apparatus 1100 also includes: a perspective keeping module 1150.

The perspective keeping module 1150 is configured to control the virtual object to keep the first perspective unchanged in response to moving the touch position of the first touch operation, in a case that the custom operation rule is the second operation rule.

In an exemplary embodiment, as shown in FIG. 12, the apparatus 1100 also includes: an operation receiving module 1160.

The operation receiving module 1160 is configured to receive the second touch operation. The initial touch position of the second touch operation is the third position located outside the response region of the first function control.

The picture adjustment module 1130 is also configured to display the third virtual environment picture in response to moving the touch position of the second touch operation from the third position to the fourth position, in a case that the custom operation rule is the second operation rule. The third virtual environment picture is the picture for observing the virtual environment in the third perspective of the virtual object, and the third perspective and the second perspective have different orientations.

In an exemplary embodiment, the picture adjustment module 1130 is also configured to display the fourth virtual environment picture in response to moving the touch position of the first touch operation from the first position to the fifth position located in the response region of the first function control, in a case that the custom operation rule is the third operation rule. The fourth virtual environment picture is the picture for observing the virtual environment in the fourth perspective of the virtual object, and the fourth perspective and the first perspective have different orientations.

In an exemplary embodiment, the rule acquisition module 1140 is configured to display the configuration interface including selection items corresponding to the plurality of candidate operation rules, and to set the target operation rule as the custom operation rule in response to the operation on the selection item corresponding to the target operation rule in the plurality of candidate operation rules.

In an exemplary embodiment, the object control module 1120 is further configured to control the virtual object to perform the behavior corresponding to the second function control in response to moving the touch position of the first touch operation from the first position to the sixth position located in the response region of the second function control.

In an exemplary embodiment, the object control module 1120 is further configured to perform the step of controlling the virtual object to perform the behavior corresponding to the second function control in a case that the behavior corresponding to the second function control and the behavior corresponding to the first function control are non-mutually exclusive behaviors, alternatively, to control the virtual object to skip performing the behavior corresponding to the second function control in a case that the behavior corresponding to the second function control and the behavior corresponding to the first function control are mutually exclusive behaviors.

In an exemplary embodiment, the object control module 1020 is further configured to periodically control the virtual object to perform the behavior corresponding to the first function control in a case that the second position is located in the extended response region of the first function control, alternatively, to control the virtual object to skip performing the behavior corresponding to the first function control in a case that the second location is located outside the extended response region of the first function control. The extended response region of the first function control surrounds the response region of the first function control.

In an exemplary embodiment, the virtual environment is the virtual environment in shooting application.

In summary, in the technical solutions provided by embodiments of this disclosure, the virtual object is controlled to perform the behavior corresponding to the first function control through the first touch operation on the first function control. And in a case that the touch position of the first touch operation moves from the first position to the second position located outside the response region of the first function control, the virtual object is adjusted from the first perspective to the second perspective, and further, the second virtual environment picture is displayed with the second perspective as a reference. In other words, in the same touch operation, not only the virtual object enables to be controlled to perform a corresponding behavior, but also the virtual environment picture enables to be adjusted according to changes of the touch position. When a user controls the virtual object to perform a certain behavior, the perspective of the virtual object may be adjusted by swiping the finger to adjust a displayed virtual environment picture. In a case that the user does not release the finger, a client may still respond to a swiping operation of the user, which simplifies a user operation and improves an adjustment efficiency of the virtual environment picture while controlling a virtual object to perform a behavior.

It should be noted that the apparatus provided in the above-mentioned embodiment only exemplifies the division of the above-mentioned function modules when implementing the functions thereof, and in practical application, the above-mentioned functions may be assigned by different function modules according to needs, i.e., dividing the internal structure of the device into different function modules to complete all or portion of the above-mentioned functions. In addition, the apparatus embodiment and the method embodiment provided by the above-mentioned embodiments belongs to the same idea, and the specific implementation process thereof is described in detail in the method embodiment, which will not be repeated here.

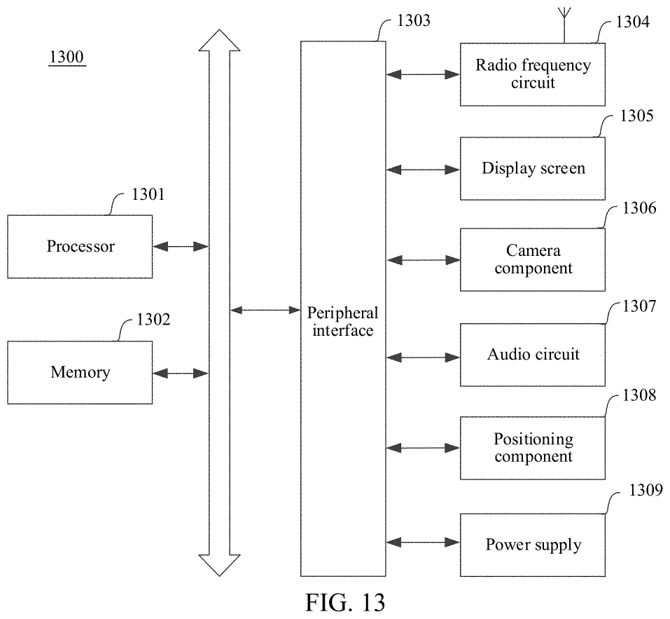

Referring to FIG. 13, a structure block diagram of a terminal 1300 provided by one embodiment of this disclosure is shown. This terminal 1300 may be an electronic device such as the mobile phone, the tablet computer, the game host, the electronic book reader, the multimedia playback device, the wearable device, and the PC. The terminal is configured to implement the display method of the virtual environment picture provided in the above-mentioned embodiment. This terminal may be the terminal 10 in the game execution environment shown in FIG. 1. Specifically:

generally, the terminal 1300 includes: a processor 1301 (processing circuitry) and a memory 1302 (non-transitory computer-readable storage medium).

The processor 1301 may include one or more processing cores, for example, a 4-core processor or an 8-core processor. The processor 1301 may be implemented in at least one of hardware forms of digital signal processing (DSP), field programmable gate array (FPGA), and programmable logic array (PLA). The processor 1301 may also include a master processor and a coprocessor. The master processor is a processor configured to process data in a wake-up state, also referred to as a central processing unit (CPU). The coprocessor is a low-power processor configured to process data in a standby state. In some embodiments, the processor 1301 may be integrated with a graphics processing unit (GPU). The GPU is configured to render and draw the content that the display screen needs to display. In some embodiments, the processor 1301 may further include an artificial intelligence (AI) processor. The AI processor is configured to process computing operations related to machine learning.

The memory 1302 may include one or more computer-readable storage media. The computer-readable storage medium may be non-transient. The memory 1302 may further include a high-speed random access memory and a nonvolatile memory, for example, one or more disk storage devices or flash storage devices. In some embodiments, a non-transitory computer-readable storage medium in the memory 1302 is used for storing at least one instruction, at least one piece of program, a set of codes, or a set of instructions configured to be performed by one or more processors to implement the above-described display method of the virtual environment picture.

In some embodiments, the terminal 1300 may also include: a peripheral interface 1303 and at least one peripheral. The processor 1301, the memory 1302, and the peripheral interface 1303 may be connected through a bus or a signal line. Each peripheral may be connected to the peripheral interface 1303 through the bus, the signal line, or a circuit board. Specifically, the peripheral includes: at least one of a radio frequency circuit 1304, a display screen 1305, a camera 1306, an audio circuit 1307, a positioning component 1308, and a power supply 1309.

It is to be understood by a person skilled in the art that the structure shown in FIG. 13 does not constitute a limitation of the terminal 1300 and may include more or fewer components than shown, or a combination of certain components, or a different arrangement of components.

In addition, embodiments of this disclosure also provide a storage medium for storing the computer program. The computer program is used for executing the methods provided by the above-mentioned embodiments.

Embodiments of this disclosure also provide a computer program product including instructions. When running on the computer, the computer program product causes the computer to perform the methods provided by the above-mentioned embodiments.

The computer-readable storage medium may include: a read only memory (ROM), a random access memory (RAM), solid state drives (SSD) or optical disk, etc. The RAM may include a resistance random access memory (ReRAM) and a dynamic random access memory (DRAM).

In an exemplary embodiment, there is also provided a computer program product. When the computer program product is performed by the processor, it is configured to implement the above-described display method of the virtual environment picture.

As mentioned herein, the term “a plurality of” means two or more than two. The term “and/or”, describing an associated relationship of associated objects, means that there may be three relationships. For example, A and/or B, may mean that: there are three cases of A alone, A and B together, and B alone. The character “/” generally means an “or” relationship between the contextual associated objects. In addition, the step numbers described in this specification merely exemplarily show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in the embodiments of this disclosure.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing disclosure includes some exemplary embodiments of this disclosure which are not intended to limit the scope of this disclosure. Other embodiments shall also fall within the scope of this disclosure.

What is claimed is:

1. A display method of a virtual environment picture, the method comprising:
displaying a first virtual environment picture, the first virtual environment picture being a picture for observing a virtual environment including a virtual object from a first perspective;
controlling the virtual object to perform a first function in response to a first touch operation on a first function control, at least a part of the first touch operation being located in a response region of the first function control; and
changing a displayed perspective of the virtual environment in response to moving a touch position of the first touch operation from a first position to a second position, wherein at least one of the first position or the second position is located outside the response region of the first function control, and wherein the displayed perspective of the virtual environment is changed based on the moved touch position of the first touch operation.

2. The method according to claim 1, wherein the changing the displayed perspective, comprises:
acquiring the touch position of the first touch operation;
calculating a distance between the touch position of the first touch operation and a reference position of the first function control; and
determining that the touch position is located outside the response region of the first function control in response to a determination that the distance is greater than a threshold, taking the touch position as the at least one of the first position or the second position located outside the response region of the first function control and changing the displayed perspective of the virtual environment.

3. The method according to claim 2, wherein the changing the displayed perspective comprises:
acquiring direction information of the movement of the touch position of the first touch operation relative to the reference position;
determining an orientation of a second perspective according to the direction information; and
displaying the changed perspective of the virtual environment based on the orientation of the second perspective.

4. The method according to claim 1, further comprising:
obtaining a control mode selection selected from a plurality of candidate control modes, the plurality of candidate control modes comprising a first control mode, and at least one of a second control mode and a third control mode,
the first control mode defining that, for a touch operation having an initial touch position located in a response region of a function control, the touch operation fails to trigger perspective change when moving in the response region of the function control and the touch operation triggers perspective change when moving outside the response region of the function control;
the second control mode defining that, for the touch operation having the initial touch position located in the response region of the function control, the touch position of the touch operation fails to trigger perspective change when moving;
the third control mode defining that, for the touch operation having the initial touch position located in the response region of the function control, the touch position of the touch operation triggers perspective change when moving; and
performing the changing the displayed perspective of the virtual environment picture in response to the control mode selection being the first control mode and the touch position of the first touch operation moving from the first position to the second position.

5. The method according to claim 4,
wherein the control mode selection is the second control mode, and
the method further comprises, after the controlling the virtual object to perform the first function in response to the first touch operation on the first function control,
controlling the virtual object to keep displaying the virtual environment in the first perspective unchanged.

6. The method according to claim 4, wherein the control mode selection is the second control mode, and
the method further comprises
receiving a second touch operation, an initial touch position of the second touch operation being a third position located outside the response region of the first function control; and
changing the displayed perspective of the virtual environment in response to moving a touch position of the second touch operation from the third position to a fourth position, wherein the displayed perspective of the virtual environment is changed based on the moved touch position of the second touch operation.

7. The method according to claim 4, wherein the obtained control mode selection is the third control mode, and
the method further comprises changing the displayed perspective of the virtual environment in response to moving the touch position of the first touch operation from the first position to a fifth position located in the response region of the first function control, wherein the displayed perspective of the virtual environment is changed based on the moved touch position of the first touch operation.

8. The method according to claim 4, wherein the obtaining the control mode selection comprises:
displaying a configuration interface comprising selection items corresponding to the plurality of candidate control modes; and
setting one of the candidate control modes as the control mode selection in response to an operation on a selection item corresponding to the one of the candidate control modes.

9. The method according to claim 1, further comprising, after the controlling the virtual object to perform the first function in response to the first touch operation on the first function control, further comprising:
controlling the virtual object to perform a second function in response to moving the touch position of the first touch operation from the first position to a sixth position located in a response region of a second function control.

10. The method according to claim 9, before the controlling the virtual object to perform the second function control, further comprising:
determining whether the first function and the second function are mutually exclusive; and
executing the controlling the virtual object to perform the second function in response to a determination that the first function and the second function are non-mutually exclusive; and
controlling the virtual object to skip performing the second function in response to a determination that the first function and the second function are mutually exclusive.

11. The method according to claim 1, wherein
an extended response region of the first function control surrounds the response region of the first function control, and
the method further comprises controlling the virtual object to repeatedly perform the first function in response to a determination that the second position is located in the extended response region of the first function control; and
controlling the virtual object to skip performing the first function in response to a determination that the second position is located outside the extended response region of the first function control.

12. The method according to claim 1, wherein the virtual environment is part of a shooting application.

13. An apparatus for displaying a virtual environment picture, comprising:
processing circuitry configured to
display a first virtual environment picture, the first virtual environment picture being a picture for observing a virtual environment including a virtual object from in a first perspective; control the virtual object to perform a first function in response to a first touch operation on a first function control, at least a part of the first touch operation being located in a response region of the first function control; and
change a displayed perspective of the virtual environment in response to moving a touch position of the first touch operation from a first position to a second position, wherein at least one of the first position or the second position is located outside the response region of the first function control, and wherein the displayed perspective of the virtual environment is changed based on the moved touch position of the first touch operation.

14. The apparatus according to claim 13, wherein the processing circuitry is further configured to:
acquire the touch position of the first touch operation;
calculate a distance between the touch position of the first touch operation and a reference position of the first function control; and
determine that the touch position is located outside the response region of the first function control in response to a determination that the distance is greater than a threshold, take the touch position as the at least one of the first position or the second position located outside the response region of the first function control and change the displayed perspective of the virtual environment.

15. The apparatus according to claim 14, wherein the processing circuitry is further configured to:
acquire direction information of the movement of the touch position of the first touch operation relative to the reference position;
determine an orientation of a second perspective according to the direction information; and
display the changed perspective of the virtual environment based on the orientation of the second perspective.

16. The apparatus according to claim 13, wherein the processing circuitry is further configured to:
obtain a control mode selection selected from a plurality of candidate control modes, the plurality of candidate control modes comprising a first control mode, and at least one of a second control mode and a third control mode,
the first control mode defining that, for a touch operation having an initial touch position located in a response region of a function control, the touch operation fails to trigger perspective change when moving in the response region of the function control and the touch operation triggers perspective change when moving outside the response region of the function control;
the second control mode defining that, for the touch operation having the initial touch position located in the response region of the function control, the touch position of the touch operation fails to trigger perspective change when moving;
the third control mode defining that, for the touch operation having the initial touch position located in the response region of the function control, the touch position of the touch operation triggers perspective change when moving; and
perform the changing the displayed perspective of the virtual environment picture in response to the control mode selection being the first control mode and the touch position of the first touch operation moving from the first position to the second position.

17. The apparatus according to claim 16,
wherein the control mode selection is the second control mode, and
the processing circuitry is further configured to, after the controlling the virtual object to perform the first function in response to the first touch operation on the first function control,
control the virtual object to keep displaying the virtual environment in the first perspective unchanged.

18. The apparatus according to claim 16, wherein the control mode selection is the second control mode, and
the processing circuitry is further configured to
receive a second touch operation, an initial touch position of the second touch operation being a third position located outside the response region of the first function control; and
change the displayed perspective of the virtual environment in response to moving a touch position of the second touch operation from the third position to a fourth position, wherein the displayed perspective of the virtual environment is changed based on the moved touch position of the second touch operation.

19. The apparatus according to claim 16, wherein the obtained control mode selection is the third control mode, and
the processing circuitry is further configured to change the displayed perspective of the virtual environment in response to moving the touch position of the first touch operation from the first position to a fifth position located in the response region of the first function control, wherein the displayed perspective of the virtual environment is changed based on the moved touch position of the first touch operation.

20. A non-transitory computer-readable storage medium storing computer-readable instructions thereon, which, when executed by processing circuitry, causes the processing circuitry to perform a display method of a virtual environment picture, the method comprising:
displaying a first virtual environment picture, the first virtual environment picture being a picture for observing a virtual environment including a virtual object from a first perspective;
controlling the virtual object to perform a first function in response to a first touch operation on a first function control, at least a part of the first touch operation being located in a response region of the first function control; and
changing a displayed perspective of the virtual environment in response to moving a touch position of the first touch operation from a first position to a second position, wherein at least one of the first position or the second position is located outside the response region of the first function control, and wherein the displayed perspective of the virtual environment is changed based on the moved touch position of the first touch operation.
